(19) United States
(12) Patent Application Publication
(10) Pub. No.: US 2012/0053258 A1
(43) Pub. Date: Mar. 1, 2012

(54) RESIN COMPOSITION AND FOAMED MOLDED BODY

(75) Inventors: Shun Kayama, Tokyo (JP); Minoru Tomita, Tokyo (JP); Yukiko Shimizu, Tokyo (JP); Terumitsu Kotani, Tokyo (JP); Kei Takahashi, Tokyo (JP)

(73) Assignees: SHOWA DENKO K.K., Minato-ku, Tokyo (JP); SONY CORPORATION, Minato-ku, Tokyo (JP)

(21) Appl. No.: 13/131,118

(22) PCT Filed: Mar. 31, 2010
(86) PCT No.: PCT/JP2010/055895

§ 371 Date: Jul. 26, 2011

(30) Foreign Application Priority Data
Sep. 30, 2009 (JP) 2009-228110

(51) Int. Cl. C08L 23/12; C08L 31/04; C08L 25/06; C08L 75/00; C08L 23/06; C08K 3/26; C08L 55/02

(52) U.S. Cl. 521/82; 524/427; 524/524; 524/521; 524/507

(57) ABSTRACT

A first resin composition of the present invention is characterized by comprising (A) at least one thermoplastic resin selected from polypropylenes, polystyrenes, acrylonitrile-butadiene-styrene copolymers, polycarbonates, polyethylenes and thermoplastic elastomers, (B) filler such as a crushed shell material or the like, and (C) binder component. A second resin composition of the present invention is characterized by comprising (A′) thermoplastic resin such as an acrylonitrile-butadiene-styrene copolymer or the like and (B′) crushed shell material, wherein the elastic modulus thereof is 1750 to 2950 MPa. A third resin composition of the present invention is characterized by comprising (A″) thermoplastic resin and (B″) crushed shell material, wherein the surface hardness thereof measured using a durometer is 12 to 85. The resin compositions of the present invention can provide molded bodies excellent in gloss, mechanical strength, and dimensional stability.

### TECHNICAL FIELD

The present invention relates to a resin composition which can provide molded body excellent in mechanical strength and dimensional stability and a foamed molded body.

### BACKGROUND ART

Resin materials prepared by formulating an inorganic filler and the like in a petroleum resin are used for covers and cases for various purposes, chassis of electrical products, and the like, due to their excellent properties such as mechanical characteristics, dimensional stability, workability, and the like.

On the other hand, several thousand tons of shells have been disposed as industrial waste in landing areas for scallops and oysters. However, illegal dumping cannot be prevented because the disposal cost is expensive. Therefore, use of a crushed scallop shell material as the inorganic filler for the above resin materials was proposed so as to effectively utilize the above shells. (For example, see Patent Literature 1.)
[Patent Literature 1] Japanese Patent Application Laid-Open No. 2004-75964

### SUMMARY OF THE INVENTION

### Technical Problem

However, as the dimensional stability of molded bodies obtained by using the resin composition described in Patent Literature 1 is relatively excellent, but the mechanical strength thereof is not sufficient, there was a problem that the molded bodies cannot be used for products whose mechanical strength must be excellent.

Therefore, the present invention is made to solve the above-mentioned problem, and an object thereof is to provide a resin composition which can provide molded bodies excellent in mechanical strength and dimensional stability.

### Solution to Problem

A first invention for achieving the above objective is a resin composition comprising (A) at least one thermoplastic resin selected from polypropylenes, polystyrenes, acrylonitrile-butadiene-styrene copolymers, polycarbonates, polyethylenes and thermoplastic elastomers, (B) at least one filler selected from a crushed shell material, a crushed chaff material and calcium carbonate, and (C) at least one binder component selected from acid-modified polyolefins, ethylene-vinyl acetate copolymers, silane coupling agents, fatty acids and paraffin wax.

At least one material selected from styrene-based thermoplastic elastomers, olefin-based thermoplastic elastomers, polyester-based thermoplastic elastomers, polyamide-based thermoplastic elastomers, urethane-based thermoplastic elastomers, nitrile-based thermoplastic elastomers, fluorine-based thermoplastic elastomers, polybutadiene-based thermoplastic elastomers, and silicone-based thermoplastic elastomer is exemplified as the thermoplastic elastomer in the first invention.

It is preferable that at least one portion of component (A) in the first invention is a recycled material. It is preferable in the first invention that component (B) is formulated in an amount of 20 to 80 wt % with respect to the total of components (A) and (B) and component (C) is formulated in an amount of 0.2 to 20 wt % with respect to the total of components (A), (B) and (C).

It is preferable that the resin composition according to the first invention further comprises a di- or higher functional compound or resin having an isocyanate group.

It is preferable that component (C) in the first invention is an ethylene-vinyl acetate copolymer having a vinyl acetate content of 65 wt % or more.

The resin composition according to the first invention may further comprise at least one biodegradable resin selected from biodegradable aliphatic polyesters, biodegradable aliphatic-aromatic copolymerized polyesters, polylactic acid, and copolymers of β-hydroxybutyric acid and β-hydroxyvaleric acid.

The resin composition according to the first invention may be used for injection molding.

A resin composition suitable for extrusion molding or foam molding can be prepared using a thermoplastic resin having an MFR (190° C.) of 0.1 to 20 g/10 minutes as component (A) in the first invention.

A second invention for achieving the above objective is a resin composition comprising (A′) at least one thermoplastic resin selected from polypropylenes, polystyrenes, acrylonitrile-butadiene-styrene copolymers, polycarbonates, polyethylenes, biodegradable resins and thermoplastic elastomers and (B′) crushed shell material, wherein component (B′) is formulated in an amount of 2 to 40 wt % with respect to the resin composition and the tensile modulus of the resin composition is 1750 to 2950 MPa.

It is preferable that component (A′) in the second invention is a thermoplastic resin comprising an acrylonitrile-butadiene-styrene copolymer as an essential component.

A third invention for achieving the above objective is a resin composition comprising (A″) at least one thermoplastic resin selected from thermoplastic elastomers and biodegradable resins and (B″) crushed shell material, wherein component (B″) is formulated in an amount of 5 to 95 wt % with respect to the resin composition and the surface hardness of the resin composition measured using a durometer is 12 to 85.

The resin compositions according to the first to third inventions may further comprise a flame retardant.

A fourth invention for achieving the above objective is a foamed molded body obtained by foaming a resin composition comprising (A′″) at least one resin selected from polyurethane resins, polyethylene resins, polypropylene resins, polystyrene resins and biodegradable resins and (B′″) crushed shell material, wherein component (B′″) is formulated in an amount of 2 to 70 wt % with respect to the resin composition and the surface hardness of the foamed molded body measured using a durometer is 12 to 95.

The foamed molded body according to the fourth invention may further comprise a flame retardant.

### Advantageous Effects of the Invention

According to the present invention, a resin composition which can provide molded body excellent in mechanical strength and dimensional stability can be provided. The molded body obtained by using the resin composition according to the present invention can be applied to precision components whose mechanical strength and dimensional precision must be high.

### DESCRIPTION OF THE EMBODIMENTS

The resin composition according to the first invention will be explained.

### Thermoplastic Resin (A)

The thermoplastic resin used in the first invention includes polypropylenes, polystyrenes, acrylonitrile-butadiene-styrene copolymers, polycarbonates, polyethylenes, styrene-based thermoplastic elastomers, olefin-based thermoplastic elastomers, polyester-based thermoplastic elastomers, polyamide-based thermoplastic elastomers, urethane-based thermoplastic elastomers, nitrile-based thermoplastic elastomers, fluorine-based thermoplastic elastomers, polybutadiene-based thermoplastic elastomers, and silicone-based thermoplastic elastomers. They may be used alone or two or more thereof may be used in combination. Further, a recycled material may be used as one portion of these thermoplastic resins. Examples of the recycled material of these thermoplastic resins include defective products and left-over materials generated in production processes, collected used products, and the like.

The styrene-based thermoplastic elastomers include copolymers of styrene and butadiene and hydrogenated products thereof. Examples thereof include Tuftec (registered trademark) soe manufactured by Asahi Kasei Chemicals Corporation, SEPTON (registered trademark) manufactured by KURARAY CO., LTD., RABALON (registered trademark) manufactured by Mitsubishi Chemical Corporation, and the like.

The olefin-based thermoplastic elastomers include those comprising a matrix of an olefin-based resin (polyethylene, polypropylene, or the like) having finely dispersed therein an olefin-based rubber (EPR or EPDM). Examples thereof include THERMORUN (registered trademark) manufactured by Mitsubishi Chemical Corporation, ESPOLEX (registered trademark) manufactured by Sumitomo Chemical Co., Ltd., and the like.

The polyester-based thermoplastic elastomers include copolymers of a polybutylene terephthalate and a polyether. Examples thereof include Hytrel (registered trademark) manufactured by DU PONT-TORAY CO., LTD. and the like.

The polyamide-based thermoplastic elastomers include block copolymers of a nylon with a polyester or a polyol, and products obtained by transesterification or condensation polymerization reaction of lactams, dicarboxylic acid polyether diols, etc., as raw materials. Examples thereof include UBESTA (registered trademark) series manufactured by Ube Industries, Ltd. and the like.

The urethane-based thermoplastic elastomers include TPU manufactured by NIPPON POLYURETHANE INDUSTRY CO., LTD.

The nitrile-based thermoplastic elastomers include those obtained by emulsion polymerization of acrylonitrile with butadiene and the like.

The fluorine-based thermoplastic elastomers include copolymers of vinylidene fluoride and hexafluoropropylene, copolymers of vinylidene fluoride, hexafluoropropylene, and tetrafluoroethylene, and the like. Examples thereof include Elaftor (registered trademark) manufactured by SHOWA HIGHPOLYMER CO., LTD., Viton (registered trademark) series manufactured by Du Pont, and the like.

The polybutadiene-based and silicone-based thermoplastic elastomers include organic silicon polymer adducts comprising a siloxane bond as a skeleton having directly bonded to the silicon atom thereof an organic group and the like. Examples thereof include KBM series manufactured by Shin-Etsu Silicone and the like.

When the resin composition according to the first invention is subjected to extrusion molding or foam molding, the MFR (measured at 190° C. under a 2.16 kg load) of the thermoplastic resin is preferably 0.1 to 20 g/10 minutes.

### Filler (B)

The filler used in the first invention is at least one material selected from a crushed shell material, a crushed chaff material, and calcium carbonate. The crushed shell material can be obtained by crushing shells of scallop, oyster, Japanese littleneck, clam, pearl oyster or the like using a hammer mill, roller mill, ball mill, jet mill, or the like. The average particle size thereof is preferably 1 to 100 μm, more preferably 5 to 50 μm, the most preferably 5 to 10 μm. The crushed chaff material can be obtained by crushing chaff by a publicly known crusher. When the crushed chaff material is formulated as the filler in the resin composition according to the first invention, the gloss of the molded body can be increased. Therefore, it is preferably applied to the use whose design must be excellent.

In the resin composition according to the first invention, component (B) above is preferably formulated in an amount of 20 to 80 wt %, more preferably 30 to 60 wt % with respect to the total of components (A) and (B). If the formulated amount of component (B) falls within the above range, the balance between the rigidity and the workability can be increased.

### Binder Component (C)

The binder component used in the first invention plays a role to increase the adhesion between components (A) and (B). The binder component includes acid-modified polyolefins, ethylene-vinyl acetate copolymers, silane coupling agents, fatty acids, and paraffin wax. They may be used alone or two or more thereof may be used in combination. The acid-modified polyolefins include graft polymers of a polyolefin such as polyethylene, polypropylene, or the like with a polymerizable carboxylic acid compound and copolymers of a resin material monomer with the polymerizable carboxylic acid compound. The polymerizable carboxylic acid compound includes maleic anhydride, itaconic anhydride, acrylic acid, methacrylic acid, maleic acid, itaconic acid, and the like. They may be used alone or two or more thereof may be used in combination. In particular, maleic anhydride is preferably used in graft polymerization. Acrylic acid, methacrylic acid, and maleic anhydride are preferably used in copolymerization. The graft ratio (or copolymerization degree) of the polymerizable carboxylic acid compound in the acid-modified polyolefin is preferably 1 to 30 wt %. The ethylene-vinyl acetate copolymer is obtained by copolymerizing ethylene with vinyl acetate and preferably has a vinyl acetate content of 65 wt % or more, more preferably 70 wt % or more, the most preferably 80 to 99 wt %, considering the strength of the molded body. Examples of the ethylene-vinyl acetate copolymer having the above vinyl acetate content include powders obtained by spray-drying an ethylene-vinyl acetate copolymer emulsion comprising polyvinyl alcohol as a protective colloid. Lawnfix (registered trademark) P3000 manufactured by SHOWA HIGHPOLYMER CO., LTD., KBE-68A and KBE-68B manufactured by KURARAY CO., LTD., and the like are exemplified as the commercially available products thereof. The silane coupling agent, the fatty acid, and paraffin wax are used in the cases where calcium carbonate is mainly formulated as the filler. The silane coupling agent includes silane coupling agents with, for example, a vinyl group, epoxy group, amino group, methacryl group, mercapto group, or the like. The fatty acid includes stearic acid, oleic acid, linoleic acid, and the like. The silane coupling agent, the fatty acid, and paraffin wax may be introduced into the resin composition by formulating calcium carbonate which had been subjected to a surface treatment therewith.

In the resin composition according to the first invention, component (C) above is preferably formulated in an amount of 0.2 to 20 wt %, more preferably 0.5 to 15 wt % with respect to the total of components (A), (B) and (C). If the formulated amount of component (C) falls within the above range, the mechanical strength can be much increased.

The di- or higher functional compound and resin having an isocyanate group may be formulated in the resin compositions according to the first invention so as to increase the strength of the molded body. The di- or higher functional compound or resin having an isocyanate group has two or more isocyanate groups in one molecule. Examples thereof include 2,4-tolylene diisocyanate, 2,6-tolylene diisocyanate, 2,4′-diphenylmethane diisocyanate, 4,4′-diphenylmethane diisocyanate, polymethylene polyphenyl diisocyanate, tolidine diisocyanate, 1,4-diisocyanatobutane, hexamethylene diisocyanate, 1,5-diisocyanato-2,2-dimethylpentane, 2,2,4-trimethyl-1,6-diisocyanatohexane, 2,4,4-trimethyl-1,6-diisocyanatohexane, 1,10-diisocyanatodecane, 1,3-diisocyanatocyclohexane, 1,4-diisocyanatocyclohexane, 1-isocyanato-3,3,5-trimethyl-5-isocyanatomethyl-cyclohexane, 4,4′-diisocyanatodicyclohexylmethane, 2,4-hexahydrotoluene diisocyanate, 2,6-hexahydrotoluene diisocyanate, perhydro-2,4′-diphenylmethane diisocyanate, perhydro-4,4′-diphenylmethane diisocyanate, naphthalene 1,5-diisocyanate, xylylene diisocyanate, 1,3-bis(isocyanatomethyl)cyclohexane, tetramethylxylene diisocyanate, and the like, the reaction products of the above compound with a monovalent or polyvalent nonionic polyalkylene ether alcohol, addition products of 2,4-tolylene diisocyanate or 2,6-tolylene diisocyanate hexamethylene diisocyanate with a polyhydric alcohol, polyisocyanurates, polyisocyanates, polyurethane resins, and the like. They may be used alone or two or more thereof may be used in combination.

Aquanate (registered trademark) 100, 105, 120, 200, and 210 manufactured by NIPPON POLYURETHANE INDUSTRY CO., LTD., Crelan (registered trademark) VPLS2256 manufactured by Bayer Corporation, and the like are exemplified as the commercially available di- or higher functional compounds and resins having an isocyanate group.

When the di- or higher functional compound or resin having an isocyanate group is formulated in the resin composition according to the first invention, the formulated amount thereof is preferably 0.5 to 3 wt % with respect to the total of components (A), (B) and (C).

In addition, at least one biodegradable resin selected from biodegradable aliphatic polyesters, biodegradable aliphatic-aromatic copolymerized polyesters, polylactic acid, and copolymers of β-hydroxybutyric acid and β-hydroxyvaleric acid may be formulated in the resin composition according to the first invention. When the biodegradable resin is formulated, it is preferable that the above-exemplified di- or higher functional compound or resin having an isocyanate group is used in combination.

Further, a surfactant may be formulated in the resin composition according to the first invention so as to further increase the molding workability and the strength of the obtained molded body. The surfactant includes nonionic surfactants, anionic surfactants, cationic surfactants, ampholytic surfactants, and the like. A nonionic surfactant which is solid at room temperature is preferable among them. Polyoxyethylene alkyl ethers, polyoxyethylene sorbitol fatty acid esters, and glycerin fatty acid esters manufactured by Kao Corporation and the like are exemplified as the commercially available products of the surfactant.

When a surfactant is added to the resin composition according to the first invention, the formulated amount thereof is preferably 0.1 to 5 wt % with respect to the total of the resin composition.

A publicly known additive other than the above components may be formulated in the resin composition according to the first invention such that the level of the effect of the present invention is not decreased. The additive includes surfactants, antioxidants, damage preventing agents, ultraviolet absorbing agents, antistatic agents, flame retardants, lubricants, colorants (dyes and pigments), foaming agents, fragrance materials, and the like. When a flame retardant is formulated in the resin composition according to the first invention, the formulated amount thereof is preferably 0.1 to 50 wt % with respect to the total of the resin composition.

The resin composition according to the first invention can be obtained by uniformly melt mixing the above components using a mixing device, such as an extruder or the like, publicly known in the technical field of the present invention. The mixing temperature is preferably higher than the melting point of the resin by about 10 to 100° C. The resin composition according to the first invention may be formed into a molded body by injection molding, blow molding, stretch blow molding, or the like, may be formed into a sheet by foam sheet molding, board forming or the like, or may be formed into a film by water-cooled inflation molding, air-cooled inflation molding, extrusion molding with a T-die, extrusion lamination molding, or the like.

The resin composition according to the second invention will be explained.

### Thermoplastic Resin (A′)

The thermoplastic resin used in the second invention includes polypropylenes, polystyrenes, acrylonitrile-butadiene-styrene copolymers, polycarbonates, polyethylenes, biodegradable resins, styrene-based thermoplastic elastomers, olefin-based thermoplastic elastomers, polyester-based thermoplastic elastomers, polyamide-based thermoplastic elastomers, urethane-based thermoplastic elastomers, nitrile-based thermoplastic elastomers, fluorine-based thermoplastic elastomers, polybutadiene-based thermoplastic elastomers, and silicone-based thermoplastic elastomers. They may be used alone or two or more thereof may be used in combination. In particular, a thermoplastic resin comprising an acrylonitrile-butadiene-styrene copolymer as an essential component is preferable, and a thermoplastic resin obtained using an acrylonitrile-butadiene-styrene copolymer in combination with a thermoplastic elastomer is more preferable. Further, a recycled material may be used as one portion of these thermoplastic resins. Examples of the recycled material of these thermoplastic resins include defective products and left-over materials generated in production processes, collected used products, and the like.

The biodegradable resins include biodegradable aliphatic polyesters, biodegradable aliphatic-aromatic copolymerized polyesters, polylactic acid, copolymers of β-hydroxybutyric acid and β-hydroxyvaleric acid, and the like. When the biodegradable resin is formulated, it is preferable that the di- or higher functional compound or resin having an isocyanate group is used in combination. Examples of the di- or higher functional compound or resin having an isocyanate group include 2,4-tolylene diisocyanate, 2,6-tolylene diisocyanate, 2,4′-diphenylmethane diisocyanate, 4,4′-diphenylmethane diisocyanate, polymethylene polyphenyl diisocyanate, tolidine diisocyanate, 1,4-diisocyanatobutane, hexamethylene diisocyanate, 1,5-diisocyanato-2,2-dimethylpentane, 2,2,4-trimethyl-1,6-diisocyanatohexane, 2,4,4-trimethyl-1,6-diisocyanatohexane, 1,10-diisocyanatodecane, 1,3-diisocyanatocyclohexane, 1,4-diisocyanatocyclohexane, 1-isocyanato-3,3,5-trimethyl-5-isocyanatomethyl-cyclohexane, 4,4′-diisocyanatodicyclohexylmethane, 2,4-hexahydrotoluene diisocyanate, 2,6-hexahydrotoluene diisocyanate, perhydro-2,4′-diphenylmethane diisocyanate, perhydro-4,4′-diphenylmethane diisocyanate, naphthalene 1,5-diisocyanate, xylylene diisocyanate, 1,3-bis(isocyanatomethyl)cyclohexane, tetramethylxylene diisocyanate, and the like, the reaction products of the above compound with a monovalent or polyvalent nonionic polyalkylene ether alcohol, addition products of 2,4-tolylene diisocyanate or 2,6-tolylene diisocyanate hexamethylene diisocyanate with a polyhydric alcohol, polyisocyanurates, polyisocyanates, polyurethane resins, and the like. They may be used alone or two or more thereof may be used in combination. Aquanate (registered trademark) 100, 105, 120, 200, and 210 manufactured by NIPPON POLYURETHANE INDUSTRY CO., LTD., Crelan (registered trademark) VPLS2256 manufactured by Bayer Corporation, and the like are exemplified as the commercially available di- or higher functional compounds and resins having an isocyanate group.

The styrene-based thermoplastic elastomers include copolymers of styrene and butadiene and hydrogenated products thereof. Examples thereof include Tuftec (registered trademark) soe manufactured by Asahi Kasei Chemicals Corporation, SEPTON (registered trademark) manufactured by KURARAY CO., LTD., RABALON (registered trademark) manufactured by Mitsubishi Chemical Corporation, and the like.

The olefin-based thermoplastic elastomers include those comprising a matrix of an olefin-based resin (polyethylene, polypropylene, or the like) having finely dispersed therein an olefin-based rubber (EPR or EPDM). Examples thereof include THERMORUN (registered trademark) manufactured by Mitsubishi Chemical Corporation, ESPOLEX (registered trademark) manufactured by Sumitomo Chemical Co., Ltd., and the like.

The polyester-based thermoplastic elastomers include copolymers of a polybutylene terephthalate and a polyether, and the like. Examples thereof include Hytrel (registered trademark) manufactured by DU PONT-TORAY CO., LTD. and the like.

The polyamide-based thermoplastic elastomers include block copolymers of a nylon with a polyester or a polyol, and products obtained by transesterification or condensation polymerization reaction of lactams, dicarboxylic acid polyether diols, etc., as raw materials. Examples thereof include UBESTA (registered trademark) series manufactured by Ube Industries, Ltd. and the like.

The urethane-based thermoplastic elastomers include TPU manufactured by NIPPON POLYURETHANE INDUSTRY CO., LTD.

The nitrile-based thermoplastic elastomers include those obtained by emulsion polymerization of acrylonitrile with butadiene and the like.

The fluorine-based thermoplastic elastomers include copolymers of vinylidene fluoride and hexafluoropropylene, copolymers of vinylidene fluoride, hexafluoropropylene, and tetrafluoroethylene, and the like. Examples thereof include Elaftor (registered trademark) manufactured by SHOWA HIGHPOLYMER CO., LTD., Viton (registered trademark) series manufactured by Du Pont, and the like.

The polybutadiene-based and silicone-based thermoplastic elastomers include organic silicon polymer adducts comprising a siloxane bond as a skeleton having directly bonded to the silicon atom thereof an organic group and the like. Examples thereof include KBM series manufactured by Shin-Etsu Silicone and the like.

In the resin composition according to the second invention, component (A′) above is preferably formulated in an amount of 60 to 98 wt %, more preferably 70 to 90 wt % with respect to the resin composition. If the formulated amount of component (A′) falls within the above range, a molded body excellent in dimensional stability, glow, and mechanical properties can be provided.

When the resin composition according to the second invention is subjected to extrusion molding or foam molding, the MFR (measured at 190° C. under a 2.16 kg load) of the thermoplastic resin is preferably 0.1 to 20 g/10 minutes.

### Crushed Shell Material (B′)

The crushed shell material can be obtained by crushing shells of scallop, oyster, Japanese littleneck, clam, pearl oyster or the like using a hammer mill, roller mill, ball mill, jet mill, or the like. The average particle size thereof is preferably 1 to 100 μm, more preferably 5 to 50 μm, the most preferably 5 to 10 μm.

In the resin composition according to the second invention, component (B′) above needs to be formulated in an amount of 2 to 40 wt %, preferably 3 to 40 wt % with respect to the resin composition. If the formulated amount of component (B′) falls within the above range, the resin composition can be uniformly and easily kneaded, natural resources can be reused, and a molded body excellent in dimensional stability, gloss, and mechanical properties can be provided.

A binder component may be formulated in the resin composition according to the second invention so as to increase the adhesion between components (A′) and (B′). The binder component includes acid-modified polyolefins, ethylene-vinyl acetate copolymers, silane coupling agents, fatty acids, and paraffin wax. They may be used alone or two or more thereof may be used in combination. The acid-modified polyolefins include graft polymers of a polyolefin such as polyethylene, polypropylene, or the like with a polymerizable carboxylic acid compound and copolymers of a resin material monomer with the polymerizable carboxylic acid compound. The polymerizable carboxylic acid compound includes maleic anhydride, itaconic anhydride, acrylic acid, methacrylic acid, maleic acid, itaconic acid, and the like. They may be used alone or two or more thereof may be used in combination. In particular, maleic anhydride is preferably used in graft polymerization. Acrylic acid, methacrylic acid, and maleic anhydride are preferably used in copolymerization. The graft ratio (or copolymerization degree) of the polymerizable carboxylic acid compound in the acid-modified polyolefin is preferably 1 to 30 wt %. The ethylene-vinyl acetate copolymer is obtained by copolymerizing ethylene with vinyl acetate and preferably has a vinyl acetate content of 65 wt % or more, more preferably 70 wt % or more, the most preferably 80 to 99 wt %, considering the strength of the molded body. Examples of the ethylene-vinyl acetate copolymer having the above vinyl acetate content include powders obtained by spray-drying an ethylene-vinyl acetate copolymer emulsion comprising polyvinyl alcohol as a protective colloid. Lawnfix (registered trademark) P3000 manufactured by SHOWA HIGHPOLYMER CO., LTD., KBE-68A and KBE-68B manufactured by KURARAY CO., LTD., and the like are exemplified as the commercially available products thereof. The silane coupling agents include silane coupling agents with, for example, a vinyl group, epoxy group, amino group, methacryl group, mercapto group, or the like. The fatty acids include stearic acid, oleic acid, linoleic acid, and the like. The silane coupling agent, the fatty acid, and paraffin wax may be introduced into the resin composition by formulating a crushed shell material which had been subjected to a surface treatment therewith.

When the binder component is formulated in the resin composition according to the second invention, the formulated amount thereof is preferably 0.1 to 5 wt % with respect to the total of the resin composition.

In addition, the above exemplified di- or higher functional compounds and resins having an isocyanate group may be formulated in the resin compositions according to the second invention so as to increase the strength of the molded body.

When the di- or higher functional compound or resin having an isocyanate group is formulated in the resin composition according to the second invention, the formulated amount thereof is preferably 0.1 to 3 wt % with respect to the total of the resin composition.

Further, a surfactant may be formulated in the resin composition according to the second invention so as to increase the molding workability and the strength of the obtained molded body. The surfactant includes nonionic surfactants, anionic surfactants, cationic surfactants, ampholytic surfactants, and the like. A nonionic surfactant which is solid at room temperature is preferable among them. Polyoxyethylene alkyl ethers, polyoxyethylene sorbitol fatty acid esters, and glycerin fatty acid esters manufactured by Kao Corporation and the like are exemplified as the commercially available products of the surfactant.

When a surfactant is formulated in the resin composition according to the second invention, the formulated amount thereof is preferably 1 to 5 wt % with respect to the total of the resin composition.

A publicly known additive other than the above components may be formulated in the resin composition according to the second invention such that the level of the effect of the present invention is not decreased. The additive includes surfactants, antioxidants, damage preventing agents, ultraviolet absorbing agents, antistatic agents, flame retardants, lubricants, colorants (dyes and pigments), foaming agents, fragrance materials, and the like. When a flame retardant is formulated in the resin composition according to the second invention, the formulated amount thereof is preferably 0.1 to 50 wt % with respect to the total of the resin composition.

The resin composition according to the second invention can be obtained by uniformly melt mixing the above components using a mixing device, such as an extruder or the like, publicly known in the technical field of the present invention. The mixing temperature is preferably higher than the melting point of the resin by about 10 to 100° C. The resin composition according to the second invention may be formed into a molded article by injection molding, blow molding, stretch blow molding, or the like, may be formed into a sheet by foam sheet molding, board forming or the like, or may be formed into a film by water-cooled inflation molding, air-cooled inflation molding, extrusion molding with a T-die, extrusion lamination molding, or the like.

The resin composition according to the second invention has a tensile modulus of 1750 to 2950 MPa. If the tensile modulus is less than 1750 MPa, the resin composition is too soft, kneading and molding steps cannot be easily carried out, and the dimensional stability of the obtained molded body is poor. If the tensile modulus is more than 2950 MPa, the resin composition is too rigid, kneading and molding steps cannot be easily carried out, and the mechanical properties of the obtained molded body are poor. The tensile modulus of the resin composition according to the second invention is preferably 1900 to 2700 MPa.

The resin composition according to the third invention will be explained.

### (A″) Thermoplastic Resin

The thermoplastic resin used in the third invention includes biodegradable resins, styrene-based thermoplastic elastomers, olefin-based thermoplastic elastomers, polyester-based thermoplastic elastomers, polyamide-based thermoplastic elastomers, urethane-based thermoplastic elastomers, nitrile-based thermoplastic elastomers, fluorine-based thermoplastic elastomers, polybutadiene-based thermoplastic elastomers, and silicone-based thermoplastic elastomers. They may be used alone or two or more thereof may be used in combination. Further, a recycled material may be used as one portion of these thermoplastic resins. Examples of the recycled material of these thermoplastic resins include defective products and left-over materials generated in production processes, collected used products, and the like.

The biodegradable resins include biodegradable aliphatic polyesters, biodegradable aliphatic-aromatic copolymerized polyesters, polylactic acid, copolymers of β-hydroxybutyric acid and β-hydroxyvaleric acid, and the like. When the biodegradable resin is formulated, it is preferable that the di- or higher functional compound or resin having an isocyanate group is used in combination. Examples of the di- or higher functional compound or resin having an isocyanate group include 2,4-tolylene diisocyanate, 2,6-tolylene diisocyanate, 2,4′-diphenylmethane diisocyanate, 4,4′-diphenylmethane diisocyanate, polymethylene polyphenyl diisocyanate, tolidine diisocyanate, 1,4-diisocyanatobutane, hexamethylene diisocyanate, 1,5-diisocyanato-2,2-dimethylpentane, 2,2,4-trimethyl-1,6-diisocyanatohexane, 2,4,4-trimethyl-1,6-diisocyanatohexane, 1,10-diisocyanatodecane, 1,3-diisocyanatocyclohexane, 1,4-diisocyanatocyclohexane, 1-isocyanato-3,3,5-trimethyl-5-isocyanatomethyl-cyclohexane, 4,4′-diisocyanatodicyclohexylmethane, 2,4-hexahydrotoluene diisocyanate, 2,6-hexahydrotoluene diisocyanate, perhydro-2,4′-diphenylmethane diisocyanate, perhydro-4,4′-diphenylmethane diisocyanate, naphthalene 1,5-diisocyanate, xylylene diisocyanate, 1,3-bis(isocyanatomethyl)cyclohexane, tetramethylxylene diisocyanate, and the like, the reaction products of the above compound with a monovalent or polyvalent nonionic polyalkylene ether alcohol, addition products of 2,4-tolylene diisocyanate or 2,6-tolylene diisocyanate hexamethylene diisocyanate with a polyhydric alcohol, polyisocyanurates, polyisocyanates, polyurethane resins, and the like. They may be used alone or two or more thereof may be used in combination. Aquanate (registered trademark) 100, 105, 120, 200, and 210 manufactured by NIPPON POLYURETHANE INDUSTRY CO., LTD., Crelan (registered trademark) VPLS2256 manufactured by Bayer Corporation, and the like are exemplified as the commercially available di- or higher functional compounds and resins having an isocyanate group.

The styrene-based thermoplastic elastomers include copolymers of styrene and butadiene and hydrogenated products thereof. Examples thereof include Tuftec (registered trademark) soe manufactured by Asahi Kasei Chemicals Corporation, SEPTON (registered trademark) manufactured by KURARAY CO., LTD., RABALON (registered trademark) manufactured by Mitsubishi Chemical Corporation, and the like.

The olefin-based thermoplastic elastomers include those comprising a matrix of an olefin-based resin (polyethylene, polypropylene, or the like) having finely dispersed therein an olefin-based rubber (EPR or EPDM). Examples thereof include THERMORUN (registered trademark) manufactured by Mitsubishi Chemical Corporation, ESPOLEX (registered trademark) manufactured by Sumitomo Chemical Co., Ltd., and the like.

The polyester-based thermoplastic elastomers include copolymers of a polybutylene terephthalate and a polyether. Examples thereof include Hytrel (registered trademark) manufactured by DU PONT-TORAY CO., LTD. and the like.

The polyamide-based thermoplastic elastomers include block copolymers of a nylon with a polyester or a polyol, and products obtained by transesterification or condensation polymerization reaction of lactams, dicarboxylic acid polyether diols, etc., as raw materials. Examples thereof include UBESTA (registered trademark) series manufactured by Ube Industries, Ltd. and the like.

The urethane-based thermoplastic elastomers include TPU manufactured by NIPPON POLYURETHANE INDUSTRY CO., LTD.

The nitrile-based thermoplastic elastomers include those obtained by emulsion polymerization of acrylonitrile with butadiene and the like.

The fluorine-based thermoplastic elastomers include copolymers of vinylidene fluoride and hexafluoropropylene, copolymers of vinylidene fluoride, hexafluoropropylene, and tetrafluoroethylene, and the like. Examples thereof include Elaftor (registered trademark) manufactured by SHOWA HIGHPOLYMER CO., LTD., Viton (registered trademark) series manufactured by Du Pont, and the like.

The polybutadiene-based and silicone-based thermoplastic elastomers include organic silicon polymer adducts comprising a siloxane bond as a skeleton having directly bonded to the silicon atom thereof an organic group and the like. Examples thereof include KBM series manufactured by Shin-Etsu Silicone and the like.

In the resin composition according to the third invention, component (A″) above is preferably formulated in an amount of 30 to 95 wt %, more preferably 40 to 60 wt % with respect to the resin composition. If the formulated amount of component (A″) falls within the above range, a molded body excellent in dimensional stability and mechanical properties can be provided.

When the resin composition according to the third invention is subjected to extrusion molding or foam molding, the MFR (measured at 190° C. under a 2.16 kg load) of the thermoplastic resin is preferably 0.1 to 20 g/10 minutes.

### (B″) Crushed Shell Material

The crushed shell material can be obtained by crushing shells of scallop, oyster, Japanese littleneck, clam, pearl oyster or the like using a hammer mill, roller mill, ball mill, jet mill, or the like. The average particle size thereof is preferably 1 to 100 μm, more preferably 5 to 50 μm, the most preferably 5 to 10 μm.

In the resin composition according to the third invention, component (B″) above needs to be formulated in an amount of 5 to 95 wt %, preferably 30 to 60 wt % with respect to the resin composition. If the formulated amount of component (B″) falls within the above range, a molded body excellent in dimensional stability and mechanical characteristics can be provided.

In addition, a binder component may be formulated in the resin composition according to the third invention so as to increase the adhesion between components (A″) and (B″). The binder component includes acid-modified polyolefins, ethylene-vinyl acetate copolymers, silane coupling agents, fatty acids, and paraffin wax. They may be used alone or two or more thereof may be used in combination. The acid-modified polyolefins include graft polymers of a polyolefin such as polyethylene, polypropylene, or the like with a polymerizable carboxylic acid compound and copolymers of a resin material monomer with the polymerizable carboxylic acid compound. The polymerizable carboxylic acid compound includes maleic anhydride, itaconic anhydride, acrylic acid, methacrylic acid, maleic acid, itaconic acid, and the like. They may be used alone or two or more thereof may be used in combination. In particular, maleic anhydride is preferably used in graft polymerization. Acrylic acid, methacrylic acid, and maleic anhydride are preferably used in copolymerization. The graft ratio (or copolymerization degree) of the polymerizable carboxylic acid compound in the acid-modified polyolefin is preferably 1 to 30 wt %. The ethylene-vinyl acetate copolymer is obtained by copolymerizing ethylene with vinyl acetate and preferably has a vinyl acetate content of 65 wt % or more, more preferably 70 wt % or more, the most preferably 80 to 99 wt %, considering the strength of the molded body. Examples of the ethylene-vinyl acetate copolymer having the above vinyl acetate content include powders obtained by spray-drying an ethylene-vinyl acetate copolymer emulsion comprising polyvinyl alcohol as a protective colloid. Lawnfix (registered trademark) P3000 manufactured by SHOWA HIGHPOLYMER CO., LTD., KBE-68A and KBE-68B manufactured by KURARAY CO., LTD., and the like are exemplified as the commercially available products thereof. The silane coupling agents include silane coupling agents with, for example, a vinyl group, epoxy group, amino group, methacryl group, mercapto group, or the like. The fatty acids include stearic acid, oleic acid, linoleic acid, and the like. The silane coupling agent, the fatty acid, and paraffin wax may be introduced into the resin composition by formulating a crushed shell material which had been subjected to a surface treatment therewith.

When a binder component is formulated in the resin composition according to the third invention, the formulated amount thereof is preferably 0.1 to 3 wt % with respect to the total of the resin composition.

Further, the above exemplified di- or higher functional compounds and resins having an isocyanate group may be formulated in the resin compositions according to the third invention so as to increase the strength of the molded body.

When a di- or higher functional compound or resin having an isocyanate group is formulated in the resin composition according to the third invention, the formulated amount thereof is preferably 0.01 to 3 wt % with respect to the total of the resin composition.

In addition, a surfactant may be formulated in the resin compositions according to the third invention so as to further increase the molding workability and the strength of the obtained molded body. The surfactant includes nonionic surfactants, anionic surfactants, cationic surfactants, ampholytic surfactants, and the like. A nonionic surfactant which is solid at room temperature is preferable among them. Polyoxyethylene alkyl ethers, polyoxyethylene sorbitol fatty acid esters, and glycerin fatty acid esters manufactured by Kao Corporation and the like are exemplified as the commercially available products of the surfactant.

When a surfactant is formulated in the resin composition according to the third invention, the formulated amount thereof is preferably 0.5 to 5 wt % with respect to the total of the resin composition.

A publicly known additive other than the above components may be added to the resin compositions according to the third invention such that the level of the effect of the present invention is not decreased. The additive includes surfactants, antioxidants, damage preventing agents, ultraviolet absorbing agents, antistatic agents, flame retardants, lubricants, colorants (dyes and pigments), foaming agents, fragrance materials, and the like. When a flame retardant is formulated in the resin composition according to the third invention, the formulated amount thereof is preferably 0.5 to 3 wt % with respect to the total of the resin composition.

The resin composition according to the third invention can be obtained by uniformly melt mixing the above components using a mixing device, such as an extruder or the like, publicly known in the technical field of the present invention. The mixing temperature is preferably higher than the melting point of the resin by about 10 to 100° C. The resin composition according to the third invention may be formed into a molded article by injection molding, blow molding, stretch blow molding, or the like, may be formed into a sheet by foam sheet molding, board forming or the like, or may be formed into a film by water-cooled inflation molding, air-cooled inflation molding, extrusion molding with a T-die, extrusion lamination molding, or the like.

The surface hardness of the resin composition according to the third invention measured using a durometer (the hardness measured using the type A durometer in accordance with JIS K6253) is 12 to 85. If the surface hardness is less than 10, the surface of the obtained molded body is easily dented, scratch is easily made thereon, and the dimensional stability thereof is poor. If the surface hardness is more than 85, the surface thereof is too rigid, it is not dented, scratch is easily made thereon, and the mechanical properties thereof are poor. The surface hardness of the resin composition according to the third invention is preferably 12 to 65.

The foamed molded body according to the fourth invention will be explained.

### (A′″) Resin

The resin used in the invention according to the fourth invention includes polyethylene resins, polypropylene resins, polystyrene resins, and biodegradable resins. They may be used alone or two or more thereof may be used in combination. Further, a recycled material may be used as one portion of these resins. Examples of the recycled material of these resins include defective products and left-over materials generated in production processes, collected used products, and the like.

The biodegradable resins include biodegradable aliphatic polyesters, biodegradable aliphatic-aromatic copolymerized polyesters, polylactic acid, copolymers of β-hydroxybutyric acid and β-hydroxyvaleric acid, and the like. When the biodegradable resin is formulated, it is preferable that the di- or higher functional compound or resin having an isocyanate group is used in combination. Examples of the di- or higher functional compound or resin having an isocyanate group include 2,4-tolylene diisocyanate, 2,6-tolylene diisocyanate, 2,4′-diphenylmethane diisocyanate, 4,4′-diphenylmethane diisocyanate, polymethylene polyphenyl diisocyanate, tolidine diisocyanate, 1,4-diisocyanatobutane, hexamethylene diisocyanate, 1,5-diisocyanato-2,2-dimethylpentane, 2,2,4-trimethyl-1,6-dlisocyanatohexane, 2,4,4-trimethyl-1,6-dlisocyanatohexane, 1,10-diisocyanatodecane, 1,3-diisocyanatocyclohexane, 1,4-diisocyanatocyclohexane, 1-isocyanato-3,3,5-trimethyl-5-isocyanatomethyl-cyclohexane, 4,4′-diisocyanatodicyclohexylmethane, 2,4-hexahydrotoluene diisocyanate, 2,6-hexahydrotoluene diisocyanate, perhydro-2,4′-diphenylmethane diisocyanate, perhydro-4,4′-diphenylmethane diisocyanate, naphthalene 1,5-diisocyanate, xylylene diisocyanate, 1,3-bis(isocyanatomethyl)cyclohexane, tetramethylxylene diisocyanate, and the like, the reaction products of the above compound with a monovalent or polyvalent nonionic polyalkylene ether alcohol, addition products of 2,4-tolylene diisocyanate or 2,6-tolylene diisocyanate hexamethylene diisocyanate with a polyhydric alcohol, polyisocyanurates, polyisocyanates, polyurethane resins, and the like. They may be used alone or two or more thereof may be used in combination. Aquanate (registered trademark) 100, 105, 120, 200, and 210 manufactured by NIPPON POLYURETHANE INDUSTRY CO., LTD., Crelan (registered trademark) VPLS2256 manufactured by Bayer Corporation, and the like are exemplified as the commercially available di- or higher functional compounds and resins having an isocyanate group.

### (B′″) Crushed Shell Material

The crushed shell material can be obtained by crushing shells of scallop, oyster, Japanese littleneck, clam, pearl oyster or the like using a hammer mill, roller mill, ball mill, jet mill, or the like. The average particle size thereof is preferably 1 to 100 μm, more preferably 5 to 50 μm, the most preferably 5 to 10 μm.

In the foamed molded body according to the fourth invention, component (B′″) above needs to be formulated in an amount of 2 to 70 wt %, preferably 30 to 60 wt % with respect to the resin composition. If the formulated amount of component (B′″) falls within the above range, a foamed molded body excellent in dimensional stability and mechanical properties can be provided.

A binder component may be formulated in the resin composition for obtaining the foamed molded body according to the fourth invention so as to increase the adhesion between components (A′″) and (B′″). The binder component includes acid-modified polyolefins, ethylene-vinyl acetate copolymers, silane coupling agents, fatty acids, and paraffin wax. They may be used alone or may be used in combination. The acid-modified polyolefins include graft polymers of a polyolefin such as polyethylene, polypropylene, or the like with a polymerizable carboxylic acid compound and copolymers of a resin material monomer with the polymerizable carboxylic acid compound. The polymerizable carboxylic acid compound includes maleic anhydride, itaconic anhydride, acrylic acid, methacrylic acid, maleic acid, itaconic acid, and the like. They may be used alone or two or more thereof may be used in combination. In particular, maleic anhydride is preferably used in graft polymerization. Acrylic acid, methacrylic acid, and maleic anhydride are preferably used in copolymerization. The graft ratio (or copolymerization degree) of the polymerizable carboxylic acid compound in the acid-modified polyolefin is preferably 1 to 30 wt %. The ethylene-vinyl acetate copolymer is obtained by copolymerizing ethylene with vinyl acetate and preferably has a vinyl acetate content of 65 wt % or more, more preferably 70 wt % or more, the most preferably 80 to 99 wt %, considering the strength of the molded body. Examples of the ethylene-vinyl acetate copolymer having the above vinyl acetate content include powders obtained by spray-drying an ethylene-vinyl acetate copolymer emulsion comprising polyvinyl alcohol as a protective colloid. Lawnfix (registered trademark) P3000 manufactured by SHOWA HIGHPOLYMER CO., LTD., KBE-68A and KBE-68B manufactured by KURARAY CO., LTD., and the like are exemplified as the commercially available products thereof. The silane coupling agents include silane coupling agents with, for example, a vinyl group, epoxy group, amino group, methacryl group, mercapto group, or the like. The fatty acids include stearic acid, oleic acid, linoleic acid, and the like. The silane coupling agent, the fatty acid, and paraffin wax may be introduced into the resin composition by formulating a crushed shell material which had been subjected to a surface treatment therewith.

When a binder component is formulated in the resin composition for obtaining the foamed molded body according to the fourth invention, the formulated amount thereof is preferably 0.1 to 3 wt % with respect to the total of the resin composition.

In addition, the above exemplified di- or higher functional compounds and resins having an isocyanate group may be formulated in the resin compositions for obtaining the foamed molded body according to the fourth invention so as to increase the strength of the foamed molded body.

When a di- or higher functional compound or resin having an isocyanate group is formulated in the resin composition for obtaining the foamed molded body according to the fourth invention, the formulated amount thereof is preferably 0.01 to 3 wt % with respect to the total of the resin composition.

Further, a surfactant may be formulated in the resin composition for obtaining the foamed molded body according to the fourth invention so as to increase the strength of the foamed molded body. The surfactant includes nonionic surfactants, anionic surfactants, cationic surfactants, ampholytic surfactants, and the like. A nonionic surfactant which is solid at room temperature is preferable among them. Polyoxyethylene alkyl ethers, polyoxyethylene sorbitol fatty acid esters, and glycerin fatty acid esters manufactured by Kao Corporation and the like are exemplified as the commercially available products of the surfactant.

When a surfactant is formulated in the resin composition for obtaining the foamed molded body according to the fourth invention, the formulated amount thereof is preferably 0.5 to 5 wt % with respect to the total of the resin composition.

A publicly known additive other than the above components may be formulated in the resin composition for obtaining the foamed molded body according to the fourth invention such that the level of the effect of the present invention is not decreased. The additive includes cell opening agents such as polyols and the like, foam adjusting agents (for example, water), crosslinkers such as 2,2′,2″-nitrotriethanol, 2-aminoethoxyethanol, and the like, catalysts such as triethylenetetramine, 1,1,4,7,7-pentamethyldiethyleneamine, 1,6-hexanediamine, diethylenetriamine, diethanolamine, pentaethylenehexamine, and the like, surfactants, antioxidants, damage preventing agents, ultraviolet absorbing agents, antistatic agents, flame retardants, lubricants, colorants (dyes and pigments), foaming agents, fragrance materials, and the like. When a flame retardant is formulated in the resin composition for obtaining the foamed molded body according to the fourth invention, the formulated amount thereof is preferably 0.5 to 3 wt % with respect to the total of the resin composition.

The foamed molded body according to the fourth invention can be obtained by uniformly mixing the above components using a mixing device publicly known in the technical field of the present invention to prepare a resin composition, providing this into a mold, and carrying out foam molding.

The surface hardness of the foamed molded body according to the fourth invention measured using a durometer (the hardness measured using the type A durometer in accordance with JIS K6253) is 12 to 95. If the surface hardness is less than 12, the surface thereof is easily dented, scratch is easily made thereon, and the dimensional stability thereof is poor. If the surface hardness is more than 95, the surface thereof is too rigid, it is not dented, scratch is easily made thereon, and the mechanical properties thereof are poor. The surface hardness of the foamed molded body according to the fourth invention is preferably 12 to 80.

### EXAMPLES

The preset invention will be specifically explained below with reference to Examples and Comparative examples. However, the present invention is not limited thereto.

### Example 1

Melt-mixing of 50 parts by weight of a polypropylene (PM870A manufactured by SunAllomer Ltd. and having a melting point of 150° C. and an MFR of 17 g/10 minutes) as the thermoplastic resin, 50 parts by weight of a crushed scallop shell material (sieved through 100 mesh) as the filler, and 0.5 part by weight of an ethylene-vinyl acetate copolymer (Lawnfix (registered trademark) P3000 manufactured by SHOWA HIGHPOLYMER CO., LTD. and having a vinyl acetate content of 90 wt %) was carried out to obtain a pellet of a resin composition. The pellet was molded into test samples having a length of 30 mm, a width of 15 mm, and a thickness of 2 mm using an injection molding machine.

### Example 2

Melt-mixing of 50 parts by weight of the polypropylene (PM870A manufactured by SunAllomer Ltd. and having a melting point of 150° C. and an MFR of 17 g/10 minutes) as the thermoplastic resin, 50 parts by weight of the crushed scallop shell material (sieved through 100 mesh) as the filler, 0.5 part by weight of the ethylene-vinyl acetate copolymer (Lawnfix (registered trademark) P3000 manufactured by SHOWA HIGHPOLYMER CO., LTD. and having a vinyl acetate content of 90 wt %), and 0.5 part by weight of Aquanate 105 (manufactured by NIPPON POLYURETHANE INDUSTRY CO., LTD.) was carried out to obtain a pellet of a resin composition. The pellet was molded into test samples having a length of 30 mm, a width of 15 mm, and a thickness of 2 mm using an injection molding machine.

### Example 3

Melt-mixing of 50 parts by weight of the polypropylene (PM870A manufactured by SunAllomer Ltd. and having a melting point of 150° C. and an MFR of 17 g/10 minutes) as the thermoplastic resin, 50 parts by weight of the crushed scallop shell material (sieved through 100 mesh) as the filler, and 2 parts by weight of a maleic anhydride-modified polypropylene (Umex (registered trademark) 1010 manufactured by Sanyo Chemical Industries, Ltd.) was carried out to obtain a pellet of a resin composition. The pellet was molded into test samples having a length of 30 mm, a width of 15 mm, and a thickness of 2 mm using an injection molding machine.

### Example 4

Melt-mixing of 50 parts by weight of an ABS (TOYOLAC (registered trademark) 700 314 B1 manufactured by Toray Industries, Inc.) as the thermoplastic resin, 30 parts by weight of the crushed scallop shell material (sieved through 100 mesh) as the filler, 0.5 part by weight of the ethylene-vinyl acetate copolymer (Lawnfix (registered trademark) P3000 manufactured by SHOWA HIGHPOLYMER CO., LTD. and having a vinyl acetate content of 90 wt %), 20 parts by weight of a polybutylene succinate (Bionolle #1010 manufactured by SHOWA HIGHPOLYMER CO., LTD. and having a melting point of 110° C., a number average molecular weight of 68,000, and an MFR of 10 g/10 minutes), and 0.5 part of Aquanate 105 (manufactured by NIPPON POLYURETHANE INDUSTRY CO., LTD.) was carried out to obtain a pellet of a resin composition. The pellet was molded into test samples having a length of 30 mm, a width of 15 mm, and a thickness of 2 mm using an injection molding machine.

### Example 5

Test samples were molded in the same manner as in Example 3 except that the granular calcium carbonate (which had been subjected to a surface treatment with stearic acid and sieved through 100 mesh) was used in place of the crushed scallop shell material.

### Example 6

Test samples were molded in the same manner as in Example 3 except that the crushed chaff material (sieved through 100 mesh) was used in place of the crushed scallop shell material.

### Example 7

Melt-mixing of 60 parts by weight of a polyester-based thermoplastic elastomer (Hytrel (registered trademark) SB754 manufactured by DU PONT-TORAY CO., LTD. and having a melting point of 160° C. and an MFR of 98 g/10 minutes at 220° C.) as the thermoplastic resin, 10 parts by weight of a polybutylene succinate (Bionolle #1300M manufactured by SHOWA HIGHPOLYMER CO., LTD. and having a melting point of 110° C. and an MFR of 100 g/10 minutes) as the biodegradable resin, 30 parts by weight of the crushed scallop shell material (sieved through 100 mesh) as the filler, 0.5 part by weight of the ethylene-vinyl acetate copolymer (Lawnfix (registered trademark) P3000 manufactured by SHOWA HIGHPOLYMER CO., LTD. and having a vinyl acetate content of 90 wt %), and 0.7 part by weigh of Aquanate 105 (manufactured by NIPPON POLYURETHANE INDUSTRY CO., LTD.) was carried out to obtain a pellet of a resin composition. The pellet was molded into test samples having a length of 30 mm, a width of 15 mm, and a thickness of 2 mm using an injection molding machine.

### Comparative Example 1

Melt-mixing of 50 parts by weight of the polypropylene (PM870A manufactured by SunAllomer Ltd. and having a melting point of 150° C. and an MFR of 17 g/10 minutes) and 50 parts by weight of the crushed scallop shell material (sieved through 100 mesh) was carried out to obtain a pellet of a resin composition. The pellet was molded into test samples having a length of 30 mm, a width of 15 mm, and a thickness of 2 mm using an injection molding machine.

### Comparative Example 2

Melt-mixing of 50 parts by weight of the polyester-based thermoplastic elastomer (Hytrel (registered trademark) SB754 manufactured by DU PONT-TORAY CO., LTD. and having a melting point of 160° C. and an MFR of 98 g/10 minutes at 220° C.) and 0.5 part by weight of the ethylene-vinyl acetate copolymer (Lawnfix (registered trademark) P3000 manufactured by SHOWA HIGHPOLYMER CO., LTD. and having a vinyl acetate content of 90 wt %) was carried out to obtain a pellet of a resin composition. The pellet was molded into test samples having a length of 30 mm, a width of 15 mm, and a thickness of 2 mm using an injection molding machine.

### Comparative Example 3

Test samples were molded in the same manner as in Example 3 except that corn starch (corn starch manufactured by Oji Cornstarch Co., Ltd.) was used in place of the crushed scallop shell material.

### <Evaluation of Mechanical Characteristics>

The test samples were subjected to tensile testing in accordance with JIS K7162 to determine the tensile strength and tensile modulus thereof. The results thereof are shown in Tables 1 to 3.

### <Evaluation of Dimensional Stability>

The test samples on which marks were made at 10 cm intervals were placed in a constant temperature incubator at 65° C. and 90% RH and were left for 150 hours. After that, the test samples were taken out from the constant temperature incubator and were left at room temperature for 24 hours. The length of the interval between the marks on the test sample was measured to determine an elongation. The results thereof are shown in Tables 1 to 3. Please note that the elongation was an average value was obtained by calculation using three measured values.

### <Evaluation of Gloss>

The surfaces of the test samples were observed by eyes to evaluate the gloss on the test samples, in accordance with the standard below. The results are shown in Tables 1 to 3.

⊚: Greatly excellent gloss

◯: Excellent gloss

X: little gloss

TABLE 1

| | Example 1 | Example 2 | Example 3 | Example 4 | Example 5 | Example 6 |
|---|---|---|---|---|---|---|
| Tensile | 23.8 | 29.7 | 25.1 | 26.6 | 22.3 | 17.5 |
| strength | | | | | | |
| (MPa) | | | | | | |
| Tensile | 1700 | 1750 | 1720 | 1660 | 1650 | 1590 |
| modulus (MPa) | | | | | | |
| Elongation | 15 | 15 | 15 | 16 | 17 | 19 |
| (%) | | | | | | |
| Gloss | ◯ | ◯ | ◯ | ◯ | ◯ | ⊚ |

TABLE 2

| | Example 7 |
|---|---|
| Tensile strength (MPa) | 16.7 |
| Tensile modulus (MPa) | 227 |
| Elongation (%) | 16 |
| Gloss | ◯ |

TABLE 3

| | Comparative | Comparative | Comparative |
|---|---|---|---|
| | example 1 | example 2 | example 3 |
| Tensile strength (MPa) | 19.0 | 10.3 | 16.3 |
| Tensile modulus (MPa) | 1650 | 25 | 1510 |
| Elongation (%) | 16 | 15 | 130 |
| Gloss | ◯ | ◯ | X |

As is clear from the results of Tables 1 to 3, the mechanical strength of the molded body obtained by using the resin compositions of Examples 1 to 5 was greatly increased, compared with that of Comparative example 1 (corresponding to a resin composition of Patent Literature 1). Comparing Example 7 with Comparative example 2 which used the thermoplastic resin elastomer, it is clear that the mechanical strength of Example 7 was increased. In addition, the levels of the mechanical strength and dimensional stability of the molded body obtained by using the resin composition of Example 6 were the same, compared with those of Comparative example 1 (corresponding to the resin composition of Patent Literature 1), while the gloss thereof was greatly excellent.

### Example 8

Melt-mixing of 79 parts by weight of an ABS (TOYOLAC (registered trademark) 700 314 B1 manufactured by Toray Industries, Inc.) as the thermoplastic resin, 1 part by weight of a polybutylene succinate (Bionolle #1010 manufactured by SHOWA HIGHPOLYMER CO., LTD. and having a melting point of 110° C., a number average molecular weight of 68,000, and an MFR of 10 g/10 minutes), 5 parts by weight of a styrene-based thermoplastic elastomer (RABALON (registered trademark) T320C manufactured by Mitsubishi Chemical Corporation), 15 parts by weight of a crushed scallop shell material (sieved through 100 mesh) as the crushed shell material, and 5 parts by weight of flame retardant (PX-200 manufactured by DAIHACHI CHEMICAL CO., LTD.) was carried out to obtain a pellet of a resin composition. The pellet was molded into test samples having a length of 30 mm, a width of 15 mm, and a thickness of 2 mm using an injection molding machine. The mechanical strength, dimensional stability, and gloss thereof were evaluated in the same manner as in Examples 1 to 7. The results thereof are shown in Table 4.

TABLE 4

| | Example 8 |
|---|---|
| Tensile strength (MPa) | 48 |
| Tensile modulus (MPa) | 2300 |
| Elongation (%) | 17 |
| Gloss | ⊚ |

As in clear from the results shown in Table 4, the mechanical strength of the molded body obtained by using the resin composition of Example 8 was greatly increased, compared with that of Comparative example 1 (corresponding to the resin composition of Patent Literature 1).

### Example 9

Melt-mixing of 50 parts by weight of a polyester-based thermoplastic elastomer (Hytrel (registered trademark) SB754 manufactured by DU PONT-TORAY CO., LTD. and having a melting point of 160° C. and an MFR of 98 g/10 minutes at 220° C.) as the thermoplastic resin, 5 parts by weight of a polybutylene succinate (Bionolle #1300M manufactured by SHOWA HIGHPOLYMER CO., LTD. and having a melting point of 110° C. and an MFR of 100 g/10 minutes), and 50 parts by weight of the crushed scallop shell material (sieved through 100 mesh) as the filler was carried out to obtain a pellet of a resin composition. The pellet was molded into test samples having a length of 30 mm, a width of 15 mm, and a thickness of 2 mm using an injection molding machine. The mechanical strength, dimensional stability, and gloss thereof were evaluated in the same manner as in Examples 1 to 7 and the surface hardness thereof was determined as one of the mechanical characteristics using a durometer. The results thereof are shown in Table 5.

TABLE 5

| | Example 9 |
|---|---|
| Hardness | 50 |
| Tensile strength (MPa) | 12.1 |
| Tensile modulus (MPa) | 32 |
| Elongation (%) | 15 |
| Gloss | ◯ |

As in clear from the results shown in Table 5, the mechanical strength and dimensional stability of the molded body obtained by using the resin composition of Example 9 were excellent.

### Example 10

Melt-mixing of a styrene-based thermoplastic elastomer (RABALON (registered trademark) T320C manufactured by Mitsubishi Chemical Corporation) as the thermoplastic resin with the crushed scallop shell material (sieved through 100 mesh) as the crushed shell material at the ratio shown in Table 6 below was carried out to obtain a pellet of a resin composition. The pellet was molded into test samples having a length of 30 mm, a width of 15 mm, and a thickness of 2 mm using an injection molding machine. The mechanical strength, dimensional stability, and gloss thereof were evaluated in the same manner as in Examples 1 to 7 and the surface hardness thereof was determined as one of the mechanical characteristics using a durometer. The results thereof are shown in Table 6.

TABLE 6

| | Example 10 | | | | | | |
|---|---|---|---|---|---|---|---|
| Thermoplastic resin | 40 | 50 | 60 | 75 | 85 | 90 | 95 |
| (wt %) | | | | | | | |
| Crushed shell | 60 | 50 | 40 | 25 | 15 | 10 | 5 |
| material (wt %) | | | | | | | |
| Hardness | 43 | 36 | 27 | 17 | 14 | 13 | 12 |
| Tensile strength | 2.5 | 2.9 | 3.2 | 3.5 | 3.6 | 3.7 | 3.8 |
| (MPa) | | | | | | | |
| Tensile modulus | 5.2 | 4.3 | 3.6 | 3.0 | 1.9 | 1.2 | 0.2 |
| (MPa) | | | | | | | |
| Elongation (%) | 40 | 47 | 54 | 63 | 68 | 72 | 85 |
| Gloss | ◯ | ◯ | ◯ | ⊚ | ⊚ | ◯ | ◯ |

As in clear from the results shown in Table 6, the mechanical strength and dimensional stability of the molded body obtained by using the resin composition of Example 10 were excellent.

### Example 11

Melt-mixing of a styrene-based thermoplastic elastomer (RABALON (registered trademark) MJ4300 manufactured by Mitsubishi Chemical Corporation) as the thermoplastic resin with the crushed scallop shell material (sieved through 100 mesh) as the crushed shell material at the ratio shown in Table 7 below was carried out to obtain a pellet of a resin composition. The pellet was molded into test samples having a length of 30 mm, a width of 15 mm, and a thickness of 2 mm using an injection molding machine. The mechanical strength, dimensional stability, and gloss thereof were evaluated in the same manner as in Examples 1 to 7 and the surface hardness thereof was determined as one of the mechanical characteristics using a durometer. The results thereof are shown in Table 7.

TABLE 7

| | Example 11 | | | | | | |
|---|---|---|---|---|---|---|---|
| Thermoplastic resin | 40 | 50 | 60 | 70 | 85 | 90 | 95 |
| (wt %) | | | | | | | |
| Crushed shell | 60 | 50 | 40 | 30 | 15 | 10 | 5 |
| material (wt %) | | | | | | | |
| Hardness | 68 | 60 | 46 | 44 | 41 | 39 | 37 |
| Tensile strength | 3.4 | 4.4 | 5.7 | 6.5 | 7.5 | 8.0 | 9.5 |
| (MPa) | | | | | | | |
| Tensile modulus | 7.8 | 5.0 | 4.2 | 3.0 | 1.5 | 1.1 | 0.7 |
| (MPa) | | | | | | | |
| Elongation (%) | 55 | 62 | 67 | 75 | 85 | 90 | 95 |
| Gloss | ◯ | ◯ | ◯ | ◯ | ⊚ | ◯ | ◯ |

As in clear from the results shown in Table 7, the mechanical strength and dimensional stability of the molded body obtained by using the resin composition of Example 11 were excellent.

### Example 12

5 parts by weight of a polybutylene succinate powder (Bionolle #1903 manufactured by SHOWA HIGHPOLYMER CO., LTD.) as the resin, 25 parts by weight of the crushed scallop shell material (sieved through 100 mesh) as the crushed shell material, 100 parts by weight of a polyol (SUNNIX FA-703 manufactured by Sanyo Chemical Industries, Ltd.), 3 parts by weight of water, 4 parts by weight of 2,2′,2′-nitrotriethanol (manufactured by KANTO CHEMICAL CO., INC.) as a crosslinker, 1 part by weight of a foam adjusting agent, and 3 parts by weight of triethylenetetramine as a catalyst were mixed at 6000 rpm for five seconds, and the mixture was charged into a separate vessel containing 160 parts by weight of a thermoplastic polyurethane (CORONATE T-80 manufactured by Nippon Polyurethane Industry Co., Ltd.) and was sufficiently mixed to obtain a liquid resin composition. The obtained liquid resin composition was provided into a mold (having an internal dimension of 35×35×10 cm and made of aluminum) whose temperature was adjusted to 90° C. such that the foam total density of the obtained liquid resin composition was about 270 kg/cm³, and then foam molding was carried out in the mold closed with a lid. After five minutes after the liquid resin composition was provided, it was defoamed to obtain a foam molded body having a density of 268 g/cm³. The tensile strength and elongation of this foamed molded body were evaluated in the same manners as in Examples 1 to 7, and they were 0.9 MPa and 63%, respectively. The surface hardness thereof was determined as one of the mechanical characteristics using a durometer, and it was 80. In addition, 25% compressive load and compressive residual strain thereof were determined, in accordance with JIS K6254. The 25% compressive load and compressive residual strain thereof were 0.09 MPa and 2.2%, respectively. After the foamed molded body was left at room temperature for 24 hours, shrinkage thereof was not observed.

As is clear from these results, the mechanical strength and dimensional stability of the foamed molded body obtained in Example 12 were excellent.

1. A resin composition comprising (A) at least one thermoplastic resin selected from polypropylenes, polystyrenes, acrylonitrile-butadiene-styrene copolymers, polycarbonates, polyethylenes and thermoplastic elastomers, (B) at least one filler selected from a crushed shell material, a crushed chaff material and calcium carbonate, and (C) at least one binder component selected from acid-modified polyolefins, ethylene-vinyl acetate copolymers, silane coupling agents, fatty acids and paraffin wax.

2. The resin composition according to claim 1, wherein component (A) is at least one selected from styrene-based thermoplastic elastomers, olefin-based thermoplastic elastomers, polyester-based thermoplastic elastomers, polyamide-based thermoplastic elastomers, urethane-based thermoplastic elastomers, nitrile-based thermoplastic elastomers, fluorine-based thermoplastic elastomers, polybutadiene-based thermoplastic elastomers and silicone-based thermoplastic elastomers.

3. The resin composition according to claim 1, wherein component (B) is formulated in an amount of 20 to 80 wt % with respect to the total of components (A) and (B) and component (C) is formulated in an amount of 0.2 to 20 wt % with respect to the total of components (A), (B) and (C).

4. The resin composition according to claim 1, further comprising a di- or higher functional compound or resin having an isocyanate group.

5. The resin composition according to claim 1, wherein component (C) is an ethylene-vinyl acetate copolymer having a vinyl acetate content of 65 wt % or more.

6. The resin composition according to claim 1, wherein at least one portion of component (A) is a recycled material.

7. The resin composition according to claim 1, further comprising at least one biodegradable resin selected from biodegradable aliphatic polyesters, biodegradable aliphatic-aromatic copolymerized polyesters, polylactic acid, and copolymers of β-hydroxybutyric acid and β-hydroxyvaleric acid.

8. The resin composition according to claim 1, wherein the resin composition is used for injection molding.

9. A resin composition for extrusion molding or foam molding, wherein the MFR (190° C.) of component (A) contained in the resin composition according to claim 1 is 0.1 to 20 g/10 minutes.

10. A resin composition comprising (A′) at least one thermoplastic resin selected from polypropylenes, polystyrenes, acrylonitrile-butadiene-styrene copolymers, polycarbonates, polyethylenes, biodegradable resins and thermoplastic elastomers and (B′) crushed shell material, wherein component (B′) is formulated in an amount of 2 to 40 wt % with respect to the resin composition and the tensile modulus of the resin composition is 1750 to 2950 MPa.

11. The resin composition according to claim 10, wherein component (A′) is a thermoplastic resin comprising an acrylonitrile-butadiene-styrene copolymer as an essential component.

12. A resin composition comprising (A″) at least one thermoplastic resin selected from thermoplastic elastomers and biodegradable resins and (B″) crushed shell material, wherein component (B″) is formulated in an amount of 5 to 95 wt % with respect to the resin composition and the surface hardness of the resin composition measured using a durometer is 12 to 85.

13. The resin composition according to claim 1, further comprising a flame retardant.

14. A foamed molded body obtained by foaming a resin composition comprising (A′″) at least one resin selected from polyurethane resins, polyethylene resins, polypropylene resins, polystyrene resins and biodegradable resins and (B′″) crushed shell material, wherein component (B′″) is formulated in an amount of 2 to 70 wt % with respect to the resin composition and the surface hardness of the foamed molded body measured using a durometer is 12 to 95.

15. The resin composition according to claim 14, further comprising a flame retardant.

16. The resin composition according to claim 2, wherein component (B) is formulated in an amount of 20 to 80 wt % with respect to the total of components (A) and (B) and component (C) is formulated in an amount of 0.2 to 20 wt % with respect to the total of components (A), (B) and (C).
